(19) United States
(12) Patent Application Publication
(10) Pub. No.: US 2026/0251068 A1
(43) Pub. Date: Aug. 27, 2026

(54) TURBINE BLADE AND GAS TURBINE

(71) Applicant: MITSUBISHI HEAVY INDUSTRIES, LTD., Tokyo (JP)

(72) Inventors: Tatsuya IWASAKI, Tokyo (JP); Takashi NIUCHI, Tokyo (JP); Yasuo MIYAHISA, Tokyo (JP); Shunsuke TORII, Tokyo (JP)

(21) Appl. No.: 18/854,237

(22) PCT Filed: Apr. 18, 2023
(86) PCT No.: PCT/JP2023/015408

§ 371 Date: Oct. 4, 2024

(30) Foreign Application Priority Data
May 20, 2022 (JP) 2022-082725

(51) Int. Cl. F01D 5/18

(52) U.S. Cl. CPC F01D 5/186; F05D 2240/301; F05D 2260/202

(57) ABSTRACT

A turbine blade according to one embodiment comprises: a first internal passage extending in a blade height direction and opening at the root of the blade; a second internal passage that extends in the blade height direction, that is formed nearer to the leading edge of a profile part than the first internal passage, and that is connected to the first internal passage at a first turn-back part on the tip-end side of the profile part; a third internal passage that extends in the blade height direction, that is formed nearest to the leading edge, and that is connected to the second internal passage at a second turn-back part on the base-end side of the profile part; and a fourth internal passage which extends in the blade height direction, and of which the end part on the tip-end side of the profile part is connected to the second turn-back part.

### TECHNICAL FIELD

The present disclosure relates to a turbine blade and a gas turbine.

The present application claims priority based on Japanese Patent Application No. 2022-082725 filed in Japan on May 20, 2022, the contents of which are incorporated herein by reference.

### BACKGROUND ART

For example, since a turbine blade used in a gas turbine or the like is used in high-temperature combustion gas, a cooling flow path for cooling is provided inside the turbine blade. A rise in temperature of a blade metal is suppressed by allowing cooling air to flow through the cooling flow path (refer to PTL 1).

### CITATION LIST

### Patent Literature

[PTL 1] Japanese Unexamined Patent Application Publication No. 2021-046853

### SUMMARY OF INVENTION

### Technical Problem

In the turbine blade described in PTL 1, a cooling flow path is formed as a serpentine flow path in which a plurality of internal passages are connected. However, as in the turbine blade described in PTL 1, in a case where the cooling flow path located closest to a leading edge side is an internal passage closest to a downstream side among the plurality of internal passages configuring the serpentine flow path, the cooling air flowing through the serpentine flow path is heated before the cooling air reaches the internal passage, so that the temperature rises. Therefore, there is a possibility that a cooling capacity will be insufficient in a region on a leading edge side of an airfoil portion.

At least one embodiment of the present disclosure is made in view of the above-described circumstances, and an object of the present disclosure is to optimize a distribution of a metal temperature of a turbine blade.

### Solution to Problem

(1) A turbine blade according to at least one embodiment of the present disclosure includes
a first internal passage that extends in a blade height direction and that is open at a root of the blade,
a second internal passage that extends in the blade height direction, is formed on a leading edge side of an airfoil portion with respect to the first internal passage, and is connected to the first internal passage at a first turn-back portion on a tip-end side of the airfoil portion,
a third internal passage that extends in the blade height direction, is formed closest to the leading edge side, and is connected to the second internal passage at a second turn-back portion on a base-end side of the airfoil portion, and
a fourth internal passage that extends in the blade height direction and of which an end portion on the tip-end side of the airfoil portion is connected to the second turn-back portion.

(2) A gas turbine according to at least one embodiment of the present disclosure includes the turbine blade with the above-described configuration of (1).

### Advantageous Effects of Invention

According to at least one embodiment of the present disclosure, a distribution of a metal temperature of the turbine blade can be optimized.

### BRIEF DESCRIPTION OF DRAWINGS

FIG. 1 is a view schematically showing a partial cross-sectional structure of a gas turbine according to one embodiment.

FIG. 2 is a cross-sectional view of an airfoil portion taken along cross sections II-II of FIGS. 3A, 3B, and 3C.

FIG. 3A is a cross-sectional view taken along line III-III of a turbine blade of FIG. 2.

FIG. 3B is a cross-sectional view taken along line III-III of the turbine blade of FIG. 2.

FIG. 3C is a cross-sectional view taken along line III-III of the turbine blade of FIG. 2.

### DESCRIPTION OF EMBODIMENTS

Hereinafter, some embodiments of the present disclosure will be described with reference to the accompanying drawings. However, dimensions, materials, shapes, and relative dispositions of components described as the embodiments or shown in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

Meanwhile, expressions of “being provided with”, “being equipped with”, “including”, or “having” one component are not exclusive expressions excluding the presence of other components.

### Outline of Gas Turbine

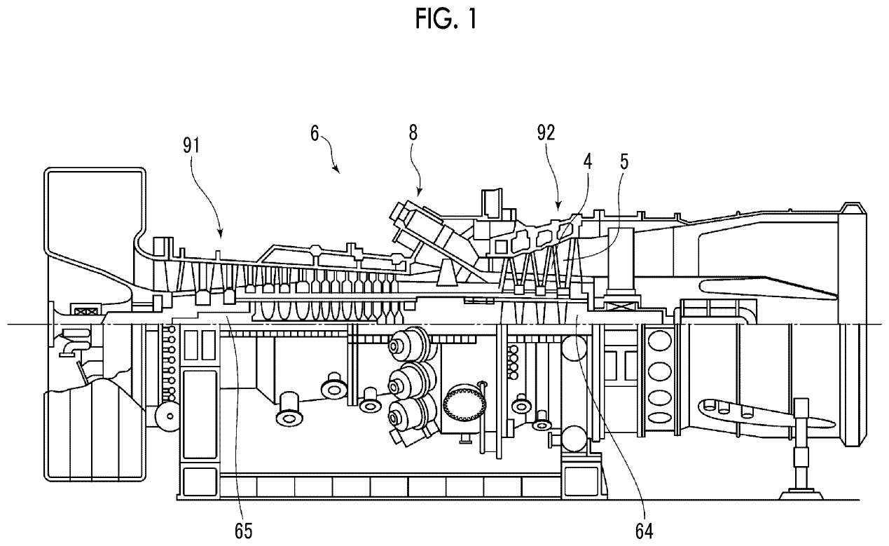

FIG. 1 is a view schematically showing a partial cross-sectional structure of a gas turbine 6 according to one embodiment. The gas turbine 6 includes a compressor 91 and a turbine 92 directly connected to each other. For example, the compressor 91 is configured as an axial compressor and takes in atmospheric air or a predetermined gas from a suction port as a working fluid to increase pressure. A combustor 8 is connected to a discharge port of the compressor 91, and the working fluid discharged from the compressor 91 is heated by the combustor 8 to a predetermined turbine inlet temperature. Then, the working fluid heated to a predetermined temperature is supplied to the turbine 92. As shown in FIG. 1, a plurality of stages of gas turbine stator blades 5 are provided inside a casing of the turbine 92. In addition, a gas turbine rotor blade 4 is attached to a rotor 64 to form a set of stages with each of the stator blades 5. One end of the rotor 64 is connected to a rotary shaft 65 of the compressor 91, and the other end is connected to a rotary shaft of a generator (not shown).

With such a configuration, in a case where a high-temperature and high-pressure working fluid is supplied from the combustor 8 to the casing of the turbine 92, the working fluid expands in the casing, so that the rotor 64 rotates to drive the generator (not shown) connected to the gas turbine 6. That is, pressure is reduced by each of the stator blades 5 fixed to the casing, and kinetic energy generated thereby is converted into rotational torque via each of the rotor blades 4 attached to the rotor 64. Then, the generated rotational torque is transmitted to the rotor 64 to drive the generator.

### Outline of Turbine Blade

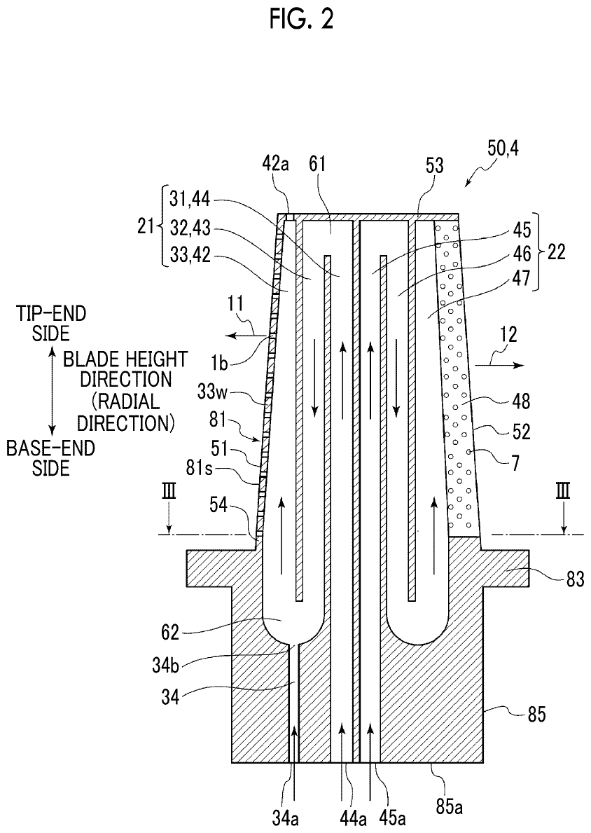

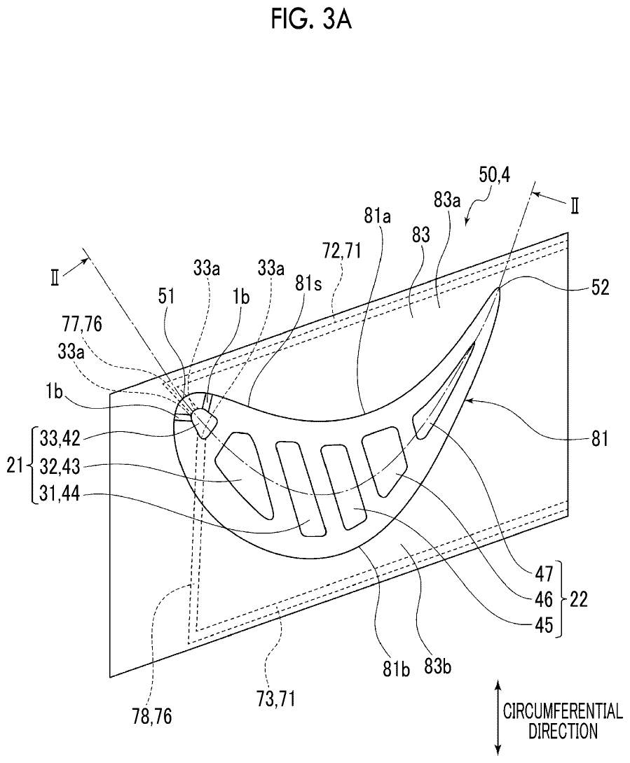

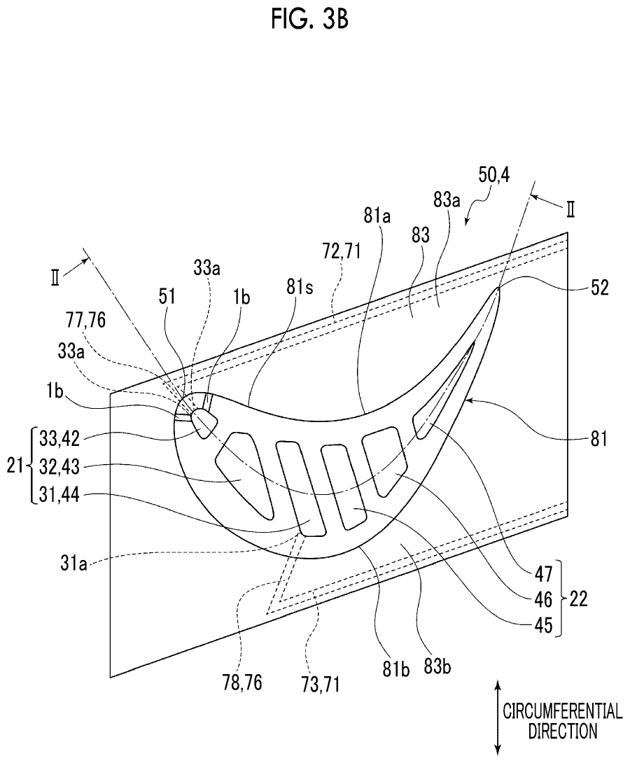

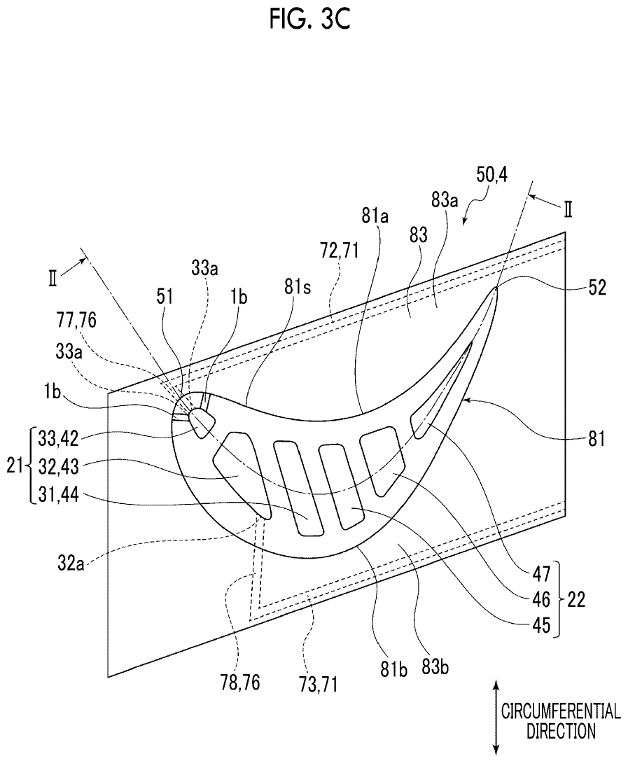

A turbine blade according to some embodiments of the present disclosure is shown in FIGS. 2, 3A, 3B, and 3C. FIG. 2 is a cross-sectional view of the airfoil portion taken along cross sections II-II in FIGS. 3A, 3B, and 3C, and FIGS. 3A, 3B, and 3C are cross-sectional views taken along line III-III of a turbine blade in FIG. 2, and show different embodiments, respectively.

A turbine blade 50 according to some embodiments is the gas turbine rotor blade 4 of the gas turbine 6 according to one embodiment, and includes an airfoil portion 81, a platform 83, and a blade root 85. The blade root 85 is embedded in the rotor 64 of the gas turbine 6, and the turbine blade 50 rotates together with the rotor 64. The platform 83 is integrally configured with the blade root 85.

The turbine blade 50 according to some embodiments includes, as shown in FIG. 2, a meandering flow path (leading edge side meandering flow path 21) that extends from a blade center portion toward a leading edge 51 while meandering, and a meandering flow path (trailing edge side meandering flow path 22) that extends from the blade center portion toward a trailing edge 52 while meandering. In the turbine blade 50 according to some embodiments, the leading edge side meandering flow path 21 and the trailing edge side meandering flow path 22 are independent flow paths.

In the turbine blade 50 according to some embodiments, for example, six cooling flow paths 42 to 47 that are flow paths configuring the leading edge side meandering flow path 21 and the trailing edge side meandering flow path 22 are provided in order from the leading edge 51 side, and a cooling flow path 48 in which a large number of pin fins 7 are provided is provided closest to a trailing edge side.

The turbine blade 50 shown in FIG. 2 includes a plurality of cooling holes 1b that are open in a vicinity of the leading edge 51, as film cooling holes blowing out film cooling air. For example, the plurality of cooling holes 1b are connected to the cooling flow path 42.

In the turbine blade 50 according to some embodiments, the cooling flow path 42, the cooling flow path 43, and the cooling flow path 44 provided in order from the leading edge 51 side are sequentially connected to each other to configure the meandering flow path (leading edge side meandering flow path 21) that extends from the blade center portion toward the leading edge 51 while meandering. In addition, the cooling flow path 45, the cooling flow path 46, and the cooling flow path 47 configure the meandering flow path (trailing edge side meandering flow path 22) that is sequentially connected toward the trailing edge 52.

In the cooling flow path 44 configuring the leading edge side meandering flow path 21, an opening portion 44a, which is an opening on one end side (inlet side), is formed at a bottom portion 85a of the blade root 85, that is, at a root of the blade. Similarly, in the cooling flow path 45 configuring the trailing edge side meandering flow path 22, an opening portion 45a, which is an opening at one end side (inlet side), is formed at the bottom portion 85a of the blade root 85.

In the following description, regarding the cooling flow path 42, the cooling flow path 43, and the cooling flow path 44 configuring the leading edge side meandering flow path 21, in order from an upstream side along a flow of cooling air, the cooling flow path 44 will also be referred to as a first internal passage 31, the cooling flow path 43 will also be referred to as a second internal passage 32, and the cooling flow path 42 will also be referred to as a third internal passage 33.

In the turbine blade 50 according to some embodiments, the first internal passage 31 extends in a blade height direction, that is, in a radial direction of the rotor 64 of the gas turbine 6, and is open at the root of the blade as described above.

The second internal passage 32 extends in the blade height direction, is formed on the leading edge 51 side of the airfoil portion 81 with respect to the first internal passage 31, and is connected to the first internal passage 31 at a first turn-back portion 61 on a tip-end 53 side of the airfoil portion 81.

The third internal passage 33 extends in the blade height direction, is formed closest to the leading edge 51 side, and is connected to the second internal passage 32 at a second turn-back portion 62 on a base-end 54 side of the airfoil portion 81.

The turbine blade 50 according to some embodiments includes a fourth internal passage 34 that extends in the blade height direction and of which an end portion 34b on the tip-end 53 side (radial direction outer side) of the airfoil portion 81 is connected to the second turn-back portion 62. Similar to the first internal passage 31, in the fourth internal passage 34, an opening portion 34a, which is an opening on one end side (inlet side), is formed at the root of the blade.

In the turbine blade 50 according to some embodiments, in the leading edge side meandering flow path 21, cooling air supplied from the opening portion 44a, which is an intake port of the cooling air, flows toward the third internal passage 33, that is, toward the leading edge 51, from the first internal passage 31 via the second internal passage 32.

In addition, the leading edge side meandering flow path 21 is also configured to be supplied with cooling air from the fourth internal passage 34. That is, the cooling air flowing into the fourth internal passage 34 from the opening portion 34a, which is an intake port of the cooling air of the fourth internal passage 34, is supplied to the second turn-back portion 62. Then, the cooling air flowing in from the fourth internal passage 34 flows into the third internal passage 33 together with cooling air from the second internal passage 32.

A part of the cooling air flowing into the third internal passage 33 is blown out from the plurality of cooling holes 1b as film cooling air 11 to perform film cooling of the airfoil portion 81 from the outside. In addition, a part of the cooling air flowing into the third internal passage 33 is blown out to the outside of the turbine blade 50 from an opening 42a formed at the tip-end of the airfoil portion 81.

Further, a part of the cooling air flowing into the third internal passage 33 is also used for cooling the platform 83, as will be described later.

In the turbine blade 50 according to some embodiments, in the trailing edge side meandering flow path 22, the cooling air supplied from the opening portion 45a, which is an intake port of the cooling air, flows from the cooling flow path 45 toward the cooling flow path 48, that is, toward the trailing edge 52, via the cooling flow path 46 and the cooling flow path 47 in this order. The cooling air is blown out from the cooling flow path 48 in which a large number of the pin fins 7 are provided, as trailing edge blown-out air 12.

In the turbine blade 50 according to some embodiments configured as described above, cooling air having a relatively low temperature is supplied from the opening portion 34a formed at the end portion on a side opposite to the end portion 34b connected to the second turn-back portion 62 of the fourth internal passage 34. As a result, the temperature of the cooling air flowing through the third internal passage 33 can be lowered as compared to a case where the fourth internal passage 34 is not provided. Accordingly, a metal temperature in a region on the leading edge 51 side of the airfoil portion 81, in which a metal temperature is higher than in a region on the trailing edge 52 side, can be suppressed. Accordingly, a distribution of a metal temperature of the turbine blade 50 can be optimized.

In addition, with the gas turbine 6 including the turbine blade 50 according to some embodiments, the distribution of the metal temperature of the turbine blade 50 can be optimized to improve lifespan of the turbine blade 50. Therefore, a maintenance frequency of the gas turbine 6 can be reduced, and maintenance costs of the gas turbine 6 can be reduced.

In the turbine blade 50 according to some embodiments, the plurality of cooling holes 1b formed in a blade wall 33w forming the third internal passage 33, communicate with the third internal passage 33, and are open to a blade surface 81s of the airfoil portion 81.

Accordingly, film cooling can be performed on the blade surface 81s of the airfoil portion 81 by the cooling air having a lower temperature as compared to a case where the fourth internal passage 34 is not provided.

As shown in FIGS. 3A, 3B, and 3C, in the turbine blade 50 according to some embodiments, the third internal passage 33 includes a third internal passage opening portion 33a for supplying the cooling air in the third internal passage 33 to the platform 83.

Accordingly, a part of the cooling air flowing through the third internal passage 33 can be supplied to the platform 83 via the third internal passage opening portion 33a after the cooling air from the fourth internal passage 34 merges. Therefore, the platform 83 can be cooled by a part of the cooling air flowing through the third internal passage 33.

As shown in FIGS. 3A, 3B, and 3C, the turbine blade 50 according to some embodiments includes a side portion cooling passage 71 formed in a side portion 83a of the platform 83 on a pressure 81a side in a suction-pressure direction of the airfoil portion 81, and a side portion 83b of the platform 83 on a suction 81b side in the suction-pressure direction of the airfoil portion 81. The side portion cooling passage 71 includes a pressure side portion cooling passage 72 formed in the side portion 83a on the pressure 81a side in the suction-pressure direction, and a suction side portion cooling passage 73 formed in the side portion 83b on the suction 81b side in the suction-pressure direction.

In the turbine blade 50 according to some embodiments, one end (upstream end) of the side portion cooling passage 71 is connected to the other end (downstream end) of a supply passage 76 to be described later, and the other end (downstream end) of the side portion cooling passage 71 is open at an end portion on the trailing edge 52 side of the platform 83.

As shown in FIGS. 3A, 3B, and 3C, the turbine blade 50 according to some embodiments includes the supply passage 76 that allows the leading edge side meandering flow path 21 and the side portion cooling passage 71 to communicate with each other. The supply passage 76 includes a pressure supply passage 77 that allows the leading edge side meandering flow path 21 and the pressure side portion cooling passage 72 to communicate with each other, and a suction supply passage 78 that allows the leading edge side meandering flow path 21 and the suction side portion cooling passage 73 to communicate with each other.

In the turbine blade 50 shown in FIG. 3A, in the pressure supply passage 77, one end (upstream end) is connected to the third internal passage opening portion 33a, and the other end (downstream end) is connected to one end of the pressure side portion cooling passage 72. In the turbine blade 50 shown in FIG. 3A, in the suction supply passage 78, one end (upstream end) is connected to the third internal passage opening portion 33a, and the other end (downstream end) is connected to one end of the suction side portion cooling passage 73.

In the turbine blade 50 shown in FIG. 3B, the first internal passage 31 includes a first internal passage opening portion 31a for supplying the cooling air in the first internal passage 31 to the platform 83.

In the turbine blade 50 shown in FIG. 3B, in the pressure supply passage 77, one end is connected to the third internal passage opening portion 33a, and the other end is connected to one end of the pressure side portion cooling passage 72. In the turbine blade 50 shown in FIG. 3B, in the suction supply passage 78, one end is connected to the first internal passage opening portion 31a, and the other end is connected to one end of the suction side portion cooling passage 73.

In the turbine blade 50 shown in FIG. 3C, the second internal passage 32 includes a second internal passage opening portion 32a for supplying the cooling air in the second internal passage 32 to the platform 83.

In the turbine blade 50 shown in FIG. 3C, in the pressure supply passage 77, one end is connected to the third internal passage opening portion 33a, and the other end is connected to one end of the pressure side portion cooling passage 72. In the turbine blade 50 shown in FIG. 3C, in the suction supply passage 78, one end is connected to the second internal passage opening portion 32a, and the other end is connected to one end of the suction side portion cooling passage 73.

As shown in FIGS. 3A, 3B, and 3C, the turbine blade 50 according to some embodiments includes the side portion cooling passage 71 formed in at least one side portion of the platform 83 in the suction-pressure direction of the airfoil portion 81, and the supply passage 76 that allows the third internal passage opening portion 33a and the side portion cooling passage 71 to communicate with each other.

Accordingly, a part of the cooling air flowing through the third internal passage 33 can be supplied to the side portion cooling passage 71 after the cooling air from the fourth internal passage 34 merges. Therefore, the platform 83 can be cooled by a part of the cooling air flowing through the third internal passage 33, in which the temperature is lowered by the cooling air from the fourth internal passage 34.

As shown in FIGS. 3A, 3B, and 3C, in the turbine blade 50 according to some embodiments, the side portion cooling passage 71 may include the pressure side portion cooling passage 72.

Accordingly, a region on the pressure 81a side of the platform 83, in which the metal temperature tends to be higher as compared to the suction 81b side, can be efficiently cooled.

As shown in FIGS. 3A, 3B, and 3C, in the turbine blade 50 according to some embodiments, the side portion cooling passage 71 may include the suction side portion cooling passage 73.

Accordingly, a region on a suction side of the platform 83 can be efficiently cooled. In addition, in a case where the pressure side portion cooling passage 72 is formed in the platform 83, the region on the suction side of the platform 83 can be cooled by the suction side portion cooling passage 73. As a result, a difference in metal temperatures between the region on the pressure side and the region on the suction side of the platform 83 is suppressed, so that a difference in thermal expansion between the two regions can be suppressed. Accordingly, since deformation of the platform 83 caused by the difference in thermal expansion between the two regions is suppressed, accumulation of low-cycle thermal fatigue is suppressed, so that the lifespan of the turbine blade 50 can be improved.

As shown in FIG. 3B, in the turbine blade 50 of one embodiment, the first internal passage 31 may include the first internal passage opening portion 31a for supplying the cooling air in the first internal passage 31 to the platform. As shown in FIG. 3B, the turbine blade 50 of one embodiment may include the pressure supply passage 77 that allows the third internal passage opening portion 33a and the pressure side portion cooling passage 72 to communicate with each other, and the suction supply passage 78 that allows the first internal passage opening portion 31a and the suction side portion cooling passage 73 to communicate with each other.

According to the turbine blade 50 shown in FIG. 3B, a part of the cooling air flowing through the third internal passage 33 can be supplied to the pressure side portion cooling passage 72 after the cooling air from the fourth internal passage 34 merges. Accordingly, the region on the pressure side of the platform 83 can be efficiently cooled by a part of the cooling air flowing through the third internal passage 33, in which the temperature is lowered by the cooling air from the fourth internal passage 34. In addition, according to the turbine blade 50 shown in FIG. 3B, a part of the cooling air flowing through the first internal passage 31 can be supplied to the suction side portion cooling passage 73. Accordingly, the region on the suction side of the platform 83 can be efficiently cooled by a part of the cooling air flowing through the first internal passage 31 having a relatively low temperature.

As shown in FIG. 3C, in the turbine blade 50 of one embodiment, the second internal passage 32 may include the second internal passage opening portion 32a for supplying the cooling air in the second internal passage 32 to the platform 83. The turbine blade 50 shown in FIG. 3C may include the pressure supply passage 77 that allows the third internal passage opening portion 33a and the pressure side portion cooling passage 72 to communicate with each other, and the suction supply passage 78 that allows the second internal passage opening portion 32a and the suction side portion cooling passage 73 to communicate with each other.

According to the turbine blade 50 shown in FIG. 3C, a part of the cooling air flowing through the third internal passage 33 can be supplied to the pressure side portion cooling passage 72 after the cooling air from the fourth internal passage 34 merges. Accordingly, the region on the pressure side of the platform 83 can be efficiently cooled by a part of the cooling air flowing through the third internal passage 33, in which the temperature is lowered by the cooling air from the fourth internal passage 34. According to the turbine blade 50 shown in FIG. 3C, as compared to a case where the suction side portion cooling passage 73 is configured to be supplied with a part of the cooling air flowing through the first internal passage 31, a cooling start position of the region on the suction side of the platform 83 by the suction side portion cooling passage 73 is easily set on the leading edge 51 side. In addition, according to the turbine blade 50 shown in FIG. 3C, as compared to a case where the suction side portion cooling passage 73 is configured to be supplied with a part of the cooling air flowing through the third internal passage 33, a length of the suction supply passage 78 can be shortened, and a temperature rise of the cooling air flowing through the suction supply passage 78 can be suppressed. Therefore, the region on the suction side of the platform 83 can be efficiently cooled.

The present disclosure is not limited to the above-described embodiments, and also includes a form in which modifications are added to the above-described embodiments or a form in which the embodiments are combined with each other as appropriate.

For example, contents described in each of the above-described embodiments are understood as follows.

(1) The turbine blade 50 according to at least one embodiment of the present disclosure includes the first internal passage 31 that extends in the blade height direction and that is open at the root of the blade, the second internal passage 32 that extends in the blade height direction, is formed on the leading edge 51 side of the airfoil portion 81 with respect to the first internal passage 31, and is connected to the first internal passage 31 at the first turn-back portion 61 on the tip-end 53 side of the airfoil portion 81, the third internal passage 33 that extends in the blade height direction, is formed closest to the leading edge 51 side, and is connected to the second internal passage 32 at the second turn-back portion 62 on the base-end 54 side of the airfoil portion 81, and the fourth internal passage 34 that extends in the blade height direction and of which the end portion 34b on the tip-end 53 side of the airfoil portion 81 is connected to the second turn-back portion 62.

According to the above-described configuration of (1), the cooling air having a relatively low temperature is supplied from the end portion on the side opposite to the end portion 34b connected to the second turn-back portion 62 of the fourth internal passage 34. As a result, the temperature of the cooling air flowing through the third internal passage 33 can be lowered as compared to a case where the fourth internal passage 34 is not provided. Accordingly, a metal temperature in a region on the leading edge 51 side of the airfoil portion 81, in which a metal temperature is higher than in a region on the trailing edge 52 side, can be suppressed. Accordingly, the distribution of the metal temperature of the turbine blade 50 can be optimized.

(2) In some embodiments, in the above-described configuration of (1), the third internal passage 33 may include the third internal passage opening portion 33a for supplying the cooling air in the third internal passage 33 to the platform 83.

According to the above-described configuration of (2), a part of the cooling air flowing through the third internal passage 33 can be supplied to the platform 83 via the third internal passage opening portion 33a after the cooling air from the fourth internal passage 34 merges. Accordingly, the platform 83 can be cooled by a part of the cooling air flowing through the third internal passage 33, in which the temperature is lowered by the cooling air from the fourth internal passage 34.

(3) In some embodiments, in the above-described configuration of (2), the side portion cooling passage 71 that is formed in at least one side portion of the platform 83 in the suction-pressure direction of the airfoil portion 81, and the supply passage 76 that allows the third internal passage opening portion 33a and the side portion cooling passage 71 to communicate with each other may be provided.

According to the above-described configuration of (3), a part of the cooling air flowing through the third internal passage 33 can be supplied to the side portion cooling passage 71 after the cooling air from the fourth internal passage 34 merges. Accordingly, the platform 83 can be cooled by a part of the cooling air flowing through the third internal passage 33, in which the temperature is lowered by the cooling air from the fourth internal passage 34.

(4) In some embodiments, in the above-described configuration of (3), the side portion cooling passage 71 may include the pressure side portion cooling passage 72 formed in the side portion 83a on the pressure 81a side in the suction-pressure direction.

According to the above-described configuration of (4), the region on the pressure 81a side of the platform 83, in which the metal temperature tends to be higher as compared to the suction 81b side, can be efficiently cooled.

(5) In some embodiments, in the above-described configuration of (3) or (4), the side portion cooling passage 71 may include the suction side portion cooling passage 73 formed in the side portion 83b on the suction 81b side in the suction-pressure direction.

According to the above-described configuration of (5), a region on the suction 81b side of the platform 83 can be efficiently cooled. In addition, in a case where the pressure side portion cooling passage 72 is formed in the platform 83, the region on the suction 81b side of the platform 83 can be cooled by the suction side portion cooling passage 73. As a result, a difference in metal temperatures between the region on the pressure 81a side and the region on the suction 81b side of the platform 83 is suppressed, so that a difference in thermal expansion between the two regions can be suppressed. Accordingly, since deformation of the platform 83 caused by the difference in thermal expansion between the two regions is suppressed, accumulation of low-cycle thermal fatigue is suppressed, so that the lifespan of the turbine blade 50 can be improved.

(6) In some embodiments, in the above-described configuration of (2), the first internal passage 31 may include the first internal passage opening portion 31a for supplying the cooling air in the first internal passage 31 to the platform 83. In some embodiments, the pressure side portion cooling passage 72 that is formed in the side portion 83a of the platform 83 on the pressure 81a side in the suction-pressure direction of the airfoil portion 81, the suction side portion cooling passage 73 that is formed in the side portion 83b of the platform 83 on the suction 81b side in the suction-pressure direction, the pressure supply passage 77 that allows the third internal passage opening portion 33a and the pressure side portion cooling passage 72 to communicate with each other, and the suction supply passage 78 that allows the first internal passage opening portion 31a and the suction side portion cooling passage 73 to communicate with each other may be provided.

According to the above-described configuration of (6), a part of the cooling air flowing through the third internal passage 33 can be supplied to the pressure side portion cooling passage 72 after the cooling air from the fourth internal passage 34 merges. Accordingly, the region on the pressure 81a side of the platform 83 can be efficiently cooled by a part of the cooling air flowing through the third internal passage 33, in which the temperature is lowered by the cooling air from the fourth internal passage 34. In addition, according to the above-described configuration of (6), a part of the cooling air flowing through the first internal passage 31 can be supplied to the suction side portion cooling passage 73. Accordingly, the region on the suction 81b side of the platform 83 can be efficiently cooled by a part of the cooling air flowing through the first internal passage 31 having a relatively low temperature.

(7) In some embodiments, in the above-described configuration of (2), the second internal passage 32 may include the second internal passage opening portion 32a for supplying the cooling air in the second internal passage 32 to the platform 83. In some embodiments, the pressure side portion cooling passage 72 that is formed in the side portion 83a of the platform 83 on the pressure 81a side in the suction-pressure direction of the airfoil portion 81, the suction side portion cooling passage 73 that is formed in the side portion 83b of the platform 83 on the suction 81b side in the suction-pressure direction, the pressure supply passage 77 that allows the third internal passage opening portion 33a and the pressure side portion cooling passage 72 to communicate with each other, and the suction supply passage 78 that allows the second internal passage opening portion 32a and the suction side portion cooling passage 73 to communicate with each other may be provided.

According to the above-described configuration of (7), a part of the cooling air flowing through the third internal passage 33 can be supplied to the pressure side portion cooling passage 72 after the cooling air from the fourth internal passage 34 merges. Accordingly, the region on the pressure 81a side of the platform 83 can be efficiently cooled by a part of the cooling air flowing through the third internal passage 33, in which the temperature is lowered by the cooling air from the fourth internal passage 34. According to the above-described configuration of (7), as compared to a case where the suction side portion cooling passage 73 is configured to be supplied with a part of the cooling air flowing through the first internal passage 31, a cooling start position of the region on the suction 81b side of the platform 83 by the suction side portion cooling passage 73 is easily set on the leading edge 51 side. In addition, according to the above-described configuration of (7), as compared to a case where the suction side portion cooling passage 73 is configured to be supplied with a part of the cooling air flowing through the third internal passage 33, the length of the suction supply passage 78 can be shortened, and the temperature rise of the cooling air flowing through the suction supply passage 78 can be suppressed. Therefore, the region on the suction 81b side of the platform 83 can be efficiently cooled.

(8) In some embodiments, in any one of the above-described configurations of (1) to (7), the plurality of cooling holes 1b that are formed in the blade wall 33w forming the third internal passage 33, communicate with the third internal passage 33, and are open to the blade surface 81s of the airfoil portion 81 may be provided.

According to the above-described configuration of (8), film cooling can be performed on the blade surface 81s of the airfoil portion 81 by the cooling air having a lower temperature as compared to a case where the fourth internal passage 34 is not provided.

(9) The gas turbine 6 according to at least one embodiment of the present disclosure includes the turbine blade 50 with any one of the above-described configurations of (1) to (8).

According to the above-described configuration of (9), the distribution of the metal temperature of the turbine blade 50 can be optimized to improve the lifespan of the turbine blade 50. Therefore, the maintenance frequency of the gas turbine 6 can be reduced, and the maintenance costs of the gas turbine 6 can be reduced.

### Reference Signs List

1b: cooling hole
6: gas turbine
4: gas turbine rotor blade (rotor blade)
21: meandering flow path (leading edge side meandering flow path)
31: first internal passage
31a: first internal passage opening portion
32: second internal passage
32a: second internal passage opening portion
33: third internal passage
33a: third internal passage opening portion
33w: blade wall
34: fourth internal passage
42 to 48: cooling flow path
50: turbine blade
61: first turn-back portion
62: second turn-back portion
71: side portion cooling passage
72: pressure side portion cooling passage
73: suction side portion cooling passage
76: supply passage
77: pressure supply passage
78: suction supply passage
81: airfoil portion
81a: pressure
81b: suction
81s: blade surface
83: platform
85: blade root

1. A turbine blade comprising:
a first internal passage that extends in a blade height direction and that is open at a root of the blade;
a second internal passage that extends in the blade height direction, is formed on a leading edge side of an airfoil portion with respect to the first internal passage, and is connected to the first internal passage at a first turn-back portion on a tip-end side of the airfoil portion;
a third internal passage that extends in the blade height direction, is formed closest to the leading edge side, and is connected to the second internal passage at a second turn-back portion on a base-end side of the airfoil portion; and
a fourth internal passage that extends in the blade height direction and of which an end portion on the tip-end side of the airfoil portion is connected to the second turn-back portion.

2. The turbine blade according to claim 1,
wherein the third internal passage includes a third internal passage opening portion for supplying cooling air in the third internal passage to a platform.

3. The turbine blade according to claim 2, further comprising:
a side portion cooling passage that is formed in at least one side portion of the platform in a suction-pressure direction of the airfoil portion; and
a supply passage that allows the third internal passage opening portion and the side portion cooling passage to communicate with each other.

4. The turbine blade according to claim 3,
wherein the side portion cooling passage includes a pressure side portion cooling passage formed in a side portion on a pressure side in the suction-pressure direction.

5. The turbine blade according to claim 3,
wherein the side portion cooling passage includes a suction side portion cooling passage formed in a side portion on a suction side in the suction-pressure direction.

6. The turbine blade according to claim 2,
wherein the first internal passage includes a first internal passage opening portion for supplying cooling air in the first internal passage to the platform, and
the turbine blade further comprises
a pressure side portion cooling passage that is formed in a side portion of the platform on a pressure side in a suction-pressure direction of the airfoil portion,
a suction side portion cooling passage that is formed in a side portion of the platform on a suction side in the suction-pressure direction,
a pressure supply passage that allows the third internal passage opening portion and the pressure side portion cooling passage to communicate with each other, and
a suction supply passage that allows the first internal passage opening portion and the suction side portion cooling passage to communicate with each other.

7. The turbine blade according to claim 2,
wherein the second internal passage includes a second internal passage opening portion for supplying cooling air in the second internal passage to the platform, and
the turbine blade further comprises
a pressure side portion cooling passage that is formed in a side portion of the platform on a pressure side in a suction-pressure direction of the airfoil portion,
a suction side portion cooling passage that is formed in a side portion of the platform on a suction side in the suction-pressure direction,
a pressure supply passage that allows the third internal passage opening portion and the pressure side portion cooling passage to communicate with each other, and
a suction supply passage that allows the second internal passage opening portion and the suction side portion cooling passage to communicate with each other.

8. The turbine blade according to claim 1, further comprising:
a plurality of cooling holes that are formed in a blade wall forming the third internal passage, communicate with the third internal passage, and are open to a blade surface of the airfoil portion.

9. A gas turbine comprising:
the turbine blade according to claim 1.

10. The turbine blade according to claim 4,
wherein the side portion cooling passage includes a suction side portion cooling passage formed in a side portion on a suction side in the suction-pressure direction.

11. The turbine blade according to claim 2, further comprising:
a plurality of cooling holes that are formed in a blade wall forming the third internal passage, communicate with the third internal passage, and are open to a blade surface of the airfoil portion.

12. A gas turbine comprising:
the turbine blade according to claim 2.
